(19) United States
(12) Patent Application Publication
(10) Pub. No.: US 2025/0173221 A1
(43) Pub. Date: May 29, 2025

(54) SELECTIVE BACKUP TO PERSISTENT MEMORY FOR VOLATILE MEMORY

(71) Applicant: SMART Modular Technologies, Inc., Newark, CA (US)

(72) Inventor: Fong-Long Lin, Fremont, CA (US)

(21) Appl. No.: 18/520,756

(22) Filed: Nov. 28, 2023

(51) Int. Cl. G06F 11/14; G06F 13/42

(52) U.S. Cl. CPC G06F 11/1451; G06F 11/1469; G06F 13/4221

(57) ABSTRACT

Systems and methods for selective backup to persistent memory from volatile memory are disclosed. A memory controller includes a detection circuit that detects whether a memory line has been modified. For example, a cache line may have a status of modified or unmodified. In the event that the cache line indicates it has been modified, that modified cache memory element is backed up in the event of power interruption. In a second example, if a memory line has an indication (e.g., in metabits) that the memory line has been modified, that modified memory line is backed up in the event of power interruption.

### BACKGROUND

### I. Field of the Disclosure

The technology of the disclosure relates generally to memory devices and backup systems for such memory devices in the event of power loss or other trigger events, such as a command.

### II. Background

Computing devices abound in modern society. The prevalence of these devices is driven in part by the many functions that are now enabled on such devices. Increased processing capabilities in such devices enable enhanced user experiences. With the advent of the myriad functions available to such devices, the size and complexity of the operating systems used to control the computing devices have increased. Likewise, there is a general trend for increasingly large and complex software applications. This increase in size and complexity requires more available memory to support the host processor. In general, most of the memory is volatile random-access memory (RAM). While volatile RAM is appropriate to meet speed, cost, and size requirements, its volatile nature makes long-term storage therein impractical. Accordingly, techniques have been developed to back up the volatile RAM to prevent complete data loss in the event of power failure or power interruption. As the size of the memory increases, there is room for innovation in how such backups are handled.

### SUMMARY

Aspects disclosed in the detailed description include systems and methods for selective backup to persistent memory from volatile memory. In an exemplary aspect, a memory controller includes a detection circuit that detects whether a memory line has been modified. For example, a cache line may have a status of modified or unmodified. In the event that the cache line indicates it has been modified, that modified cache memory element is backed up in the event of power interruption. In a second example, if a memory line has an indication (e.g., in metabits) that the memory line has been modified, that modified memory line is backed up in the event of power interruption. Exemplary aspects are particularly suited for compute express link (CXL) memory that is acting as cache or direct memory, but the disclosure is not so limited. By backing up only the modified volatile memory, the size of the power source (e.g., a battery or supercapacitor) may be reduced, potentially saving space and/or cost for the memory device.

In this regard, in one aspect, a memory device is disclosed. The memory device includes a volatile random-access memory (RAM) portion comprising a memory access line having a status identifier associated therewith indicative of whether a change has been made over the memory access line. The memory device also includes a persistent memory portion. The memory device further includes a backup memory controller configured to detect a backup event and copy data from the volatile RAM portion to the persistent memory portion based on the status identifier.

In another aspect, a method of backing up memory is disclosed. The method includes storing a status identifier related to a memory line associated with a volatile memory portion, the status identifier indicative of whether a memory access command has occurred, and responsive to a backup event, copying data from a subset of the volatile memory portion to a persistent memory portion based on the status identifier.

In another aspect, a computing device is disclosed. The computing device includes a host memory controller, a memory bus coupled to the host memory controller, and a memory device coupled to the memory bus, the memory device comprising a volatile RAM portion comprising a memory access line having a status identifier associated therewith indicative of whether a change has been made over the memory access line. The computing device also includes a persistent memory portion and a backup memory controller configured to detect a backup event and copy data from the volatile RAM portion to the persistent memory portion based on the status identifier.

### BRIEF DESCRIPTION OF THE DRAWINGS

FIG. 1 is a block diagram of an exemplary computing device having a processor and volatile memory devices that have backup persistent memory elements;

FIG. 2 is a flowchart of a conventional backup process that may be used to backup volatile memory devices;

FIG. 3A is a block diagram of a computing device with a local memory device having a controller according to exemplary aspects of the present disclosure;

FIG. 3B is a block diagram of a computing device with a remote memory device having a controller according to exemplary aspects of the present disclosure;

FIG. 4 is a flowchart illustrating an exemplary process for selectively backing up volatile memory into a persistent memory element when the volatile memory is acting as a cache; and

FIG. 5 is a flowchart illustrating an exemplary process for selectively backing up volatile memory into a persistent memory element when the volatile memory is acting as direct memory.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that although the terms first, second, etc. may be used herein to describe various elements, these elements should not be limited by these terms. These terms are only used to distinguish one element from another. For example, a first element could be termed a second element, and similarly, a second element could be termed a first element without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element, or intervening elements may also be present. In contrast, when an element is referred to as being “directly on” or extending “directly onto” another element, no intervening elements are present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, no intervening elements are present. It will also be understood that when an element is referred to as being “connected” or “coupled” to another element, it can be directly connected or coupled to the other element, or intervening elements may be present. In contrast, when an element is referred to as being “directly connected” or “directly coupled” to another element, no intervening elements are present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description include systems and methods for selective backup to persistent memory from volatile memory. In an exemplary aspect, a memory controller includes a detection circuit that detects whether a memory line has been modified. For example, a cache line may have a status of modified or unmodified. In the event that the cache line indicates it has been modified, that modified cache memory element is backed up in the event of power interruption. In a second example, if a memory line has an indication (e.g., in metabits) that the memory line has been modified, that modified memory line is backed up in the event of power interruption. Exemplary aspects are particularly suited for compute express link (CXL) memory that is acting as cache or direct memory, but the disclosure is not so limited. By backing up only the modified volatile memory, the size of the power source (e.g., a battery or supercapacitor) may be reduced, potentially saving space and/or cost for the memory device.

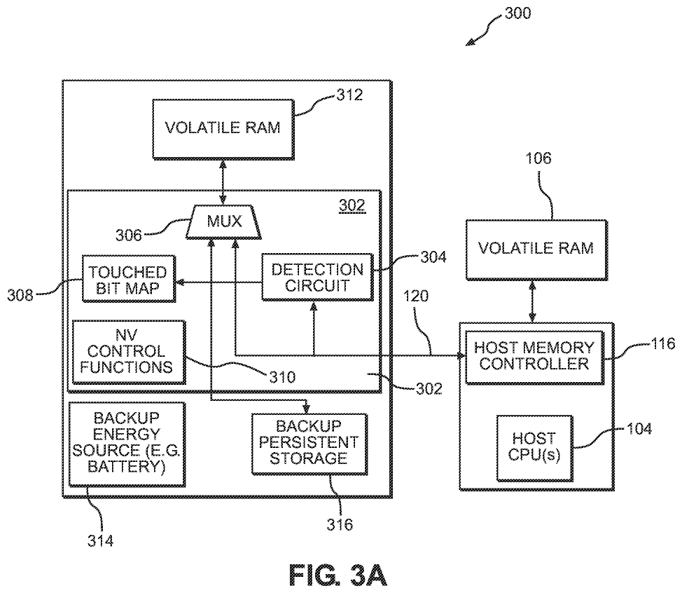

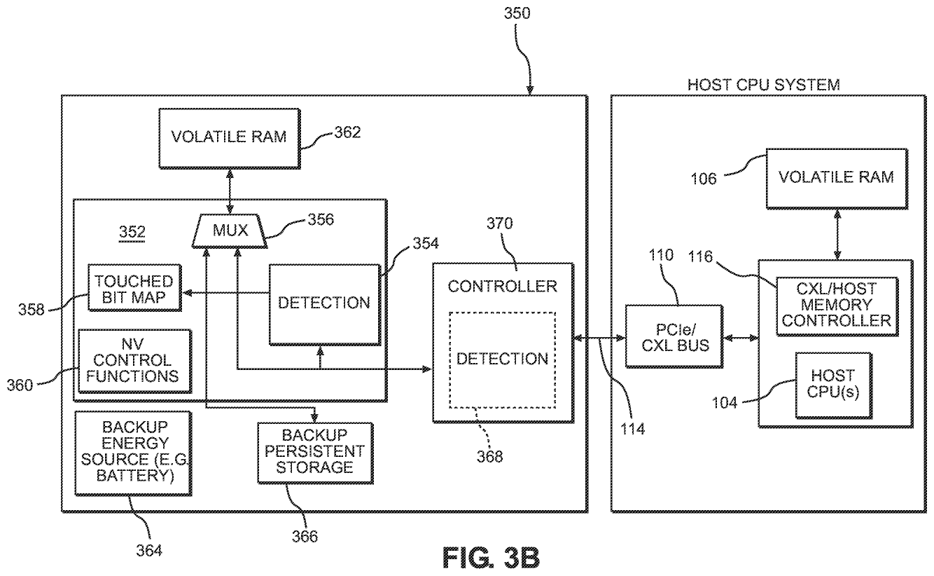

Before addressing aspects of the present disclosure, a discussion of how memory systems and their operation is provided so that the discussion of the present disclosure has context and the advantages seen by contrasting with such existing systems. A discussion of aspects of the present disclosure begins below with reference to FIG. 3A.

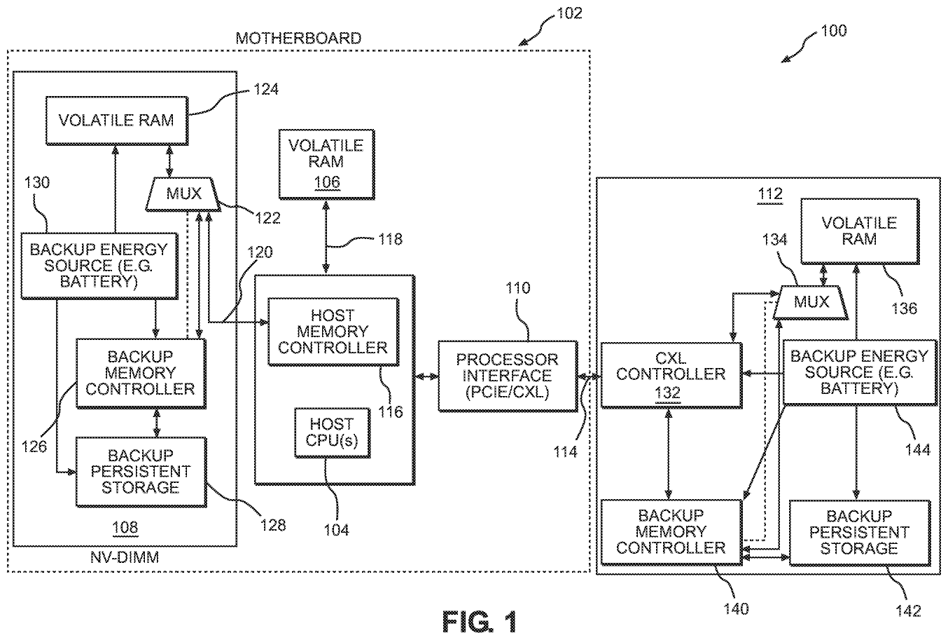

In this regard, FIG. 1 is a block diagram of a computing device 100. The computing device 100 may include a motherboard 102. The motherboard 102 may have a host processor (also sometimes referred to as a computer processing unit (CPU)) 104, a first local memory 106, and a second local memory 108. In some devices, there may be multiple host processors 104. The motherboard 102 may also have a communication interface 110 (sometimes called a processor interface) that allows communication to an external memory 112 through a bus 114. In an exemplary aspect, the bus 114 may be a peripheral component interconnect express (PCIe) bus, a CXL bus, or a CXL protocol over a PCIe physical layer.

The host processor 104 may include a host memory controller 116 that communicates with the first local memory 106 through a first internal memory bus 118. The host memory controller 116 may further communicate with the second local memory 108 through a second internal memory bus 120. The first local memory 106 may be formed from volatile random-access memory (RAM).

The second local memory 108 may include a multiplexer (mux) 122 that provides access to a volatile RAM 124. The mux 122 also communicates with a backup memory controller 126. The backup memory controller 126 is coupled to a persistent memory 128 (e.g., NAND Flash, 3D XPoint, magnetoresistive RAM (MRAM), or the like). The persistent memory 128 may also be coupled to a backup energy source (e.g., battery, supercapacitor, or hybrid capacitor such as a lithium ion capacitor (LIC)) 130. At the command of the host memory controller 116, or on detection of power loss, the backup memory controller 126 may cause the information in the volatile RAM 124 to be copied into the persistent memory 128.

Similarly, the external memory 112 may have a bus interface (not shown) that sends and receives signals over the bus 114. Received signals are passed to a control circuit 132 (or the interface may be integrated into the control circuit 132) (sometimes referred to as a controller or CXL controller) and pass through a mux 134 to a volatile RAM 136. The external memory 112 may further have a backup memory controller 140. The backup memory controller 140 may be coupled to a persistent memory 142 (e.g., NAND Flash). The persistent memory 142 may also be coupled to a backup energy source (e.g., battery or supercapacitor) 144. At the command of the host memory controller 116, or on detection of power loss, the backup memory controller 140 may cause information in the volatile RAM 136 to be copied into the persistent memory 142.

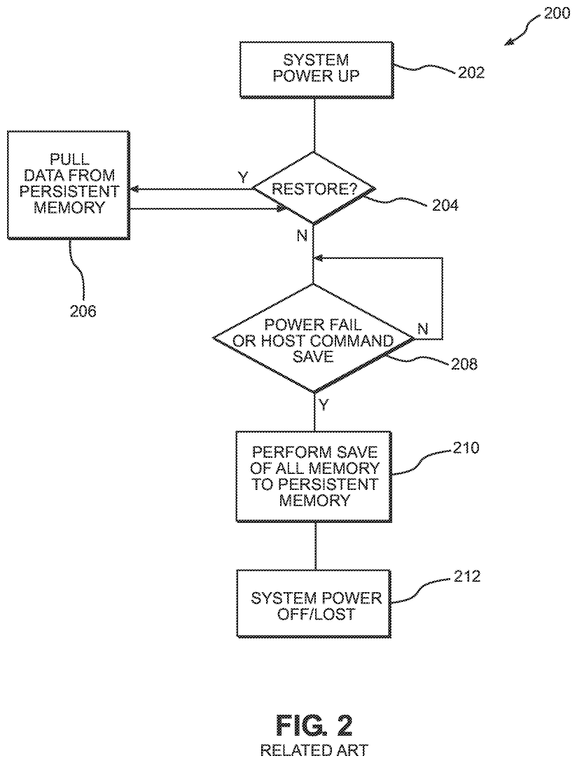

The conventional way of copying into persistent memory 128 or 142 is set forth in the process illustrated by FIG. 2 and described below. The improvements of the present disclosure begin below with reference to FIG. 3A.

In this regard, FIG. 2 illustrates a process 200 that begins on system power up (block 202) (assuming the use of second local memory 108, although a similar process is used for external memory 112). The control circuit (e.g., the host processor 104) may determine if a restore operation is needed (block 204). If the answer to block 204 is yes, the host memory controller 116 pulls data from the persistent memory 128 (block 206) to the volatile RAM 124 while additionally signaling to the host CPU(s) 104 to hold off accessing the volatile RAM 124 until the pull is complete. If the answer to block 204 is no, or after data has been pulled from persistent memory 128 to the volatile RAM 124, the backup memory controller 126 will monitor for receipt of a command to backup or detection of a power fail condition (block 208). So long as the answer to block 208 is no, normal operation continues. Once the answer to block 208 is yes, the backup memory controller 126 causes the entirety of the volatile RAM 124 to be saved into persistent memory 128 (block 210) using the backup energy source 130 to provide power long enough for the save function to complete. After such a save has completed, the system may power off or disconnect the battery in the backup energy source 130 (block 212). For the sake of simplicity, any event that triggers the copying of data from the volatile memory to the persistent memory may be considered a “backup event.”

In many cases, the volatile RAM 124 may be quite large to assist in supporting the complex software that is currently in use. Thus, a backup event (whether active from the host controller or as a result of power loss) that caused the copying of the entirety of the volatile RAM 124 to persistent memory 128 may be both time-consuming and power-intensive. The backup energy source 130 must then be designed for a worst-case scenario that allows for such a lengthy saving process. As memory sizes continue to increase, providing a sufficiently large backup energy source 130 or 144 has become difficult in terms of cost and space.

Exemplary aspects of the present disclosure add a detection circuit to the memory that reduces how much data from a volatile memory element is copied into the persistent storage. In particularly contemplated aspects, the volatile memory may be CXL memory acting as cache or direct memory. When acting as cache, the CXL controller carries a cache status (e.g., Modified, Shared, Invalid, or Exclusive). If the cache status is “modified,” then that portion of the volatile memory is copied into persistent memory. When acting as direct memory, the CXL controller may have unused metabits, which may be used to indicate that the memory line has been accessed with a write command (i.e., modified). By reading the cache status or metabits and only copying data from volatile memory that has been modified, the amount of data that is copied may be reduced. On restore, the controller may pull the copied data from the persistent memory and inform the host memory controller of the restore.

FIGS. 3A and 3B show two possible exemplary memory structures that have such a detection circuit that detects the portions of the volatile RAM that have been accessed and modified. In this regard, FIG. 3A shows a memory 300 that may, for example, be an internal memory, such as a second local memory 108. The memory 300 may have a control circuit, more specifically, a backup memory controller 302 that includes a detection circuit 304, a mux 306 (analogous to mux 122 of FIG. 1), an optional touched bit map circuit 308, and a nonvolatile control function circuit 310. The memory 300 may further include a volatile RAM 312, a backup energy source 314, and a backup persistent memory 316. When the host memory controller 116 writes to the volatile RAM 312 as cache or as memory, the detection circuit 304 detects the command and/or updates either a cache line status or metabits to reflect the change in cache placement memory (memory (e.g., direct-map, set-associative, fully-associative, or the like, none shown specifically). Optionally, this information may also be stored in the touched bit map circuit 308. Additionally, the host memory controller 116 may keep track of segmentation information and any information needed to be backed up.

Similarly, FIG. 3B shows a memory 350 that may be external memory, such as external memory 112 of FIG. 1. In an exemplary aspect, the external memory may be a nonvolatile dual in-line memory module (NV-DIMM) or RAM stick, or a nonvolatile CXL memory device. The memory 350 may have a backup memory controller 352 that includes a detection circuit 354, a mux 356 (analogous to mux 134 of FIG. 1), a touched bit map circuit 358, and a nonvolatile control function circuit 360. The memory 350 may further include a volatile RAM 362, a backup energy source 364, and a backup persistent memory 366. When the host memory controller 116 writes to the volatile RAM 362, the detection circuit 354 detects the command and/or updates either a cache line status or metabits to reflect the change. This information may be stored in the host memory controller 116 or other memory as explained above, and optionally, this information may also be stored in the touched bit map circuit 358.

Note that instead of having a detection circuit 354 in the backup memory controller 352, a detection circuit 368 may be present in CXL control circuit 370.

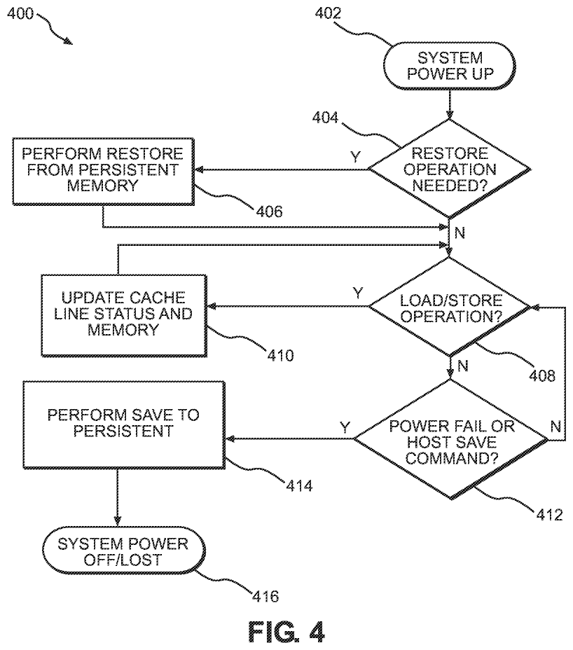

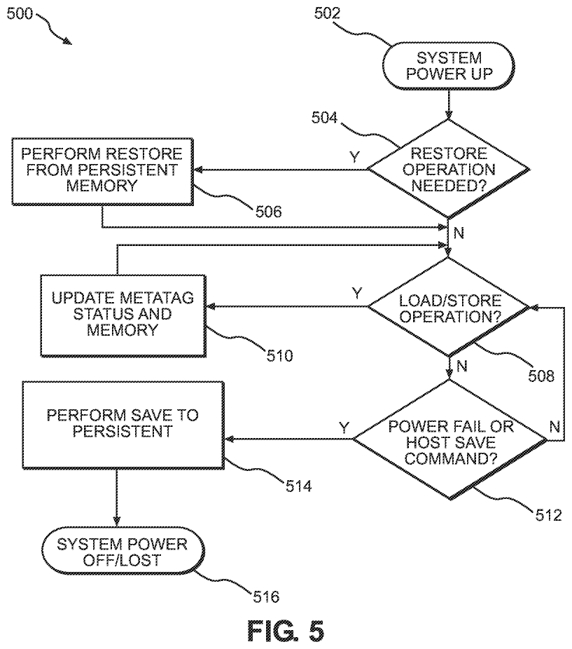

A process 400 for using the selective backup of volatile memory to persistent memory is provided with reference to FIGS. 4 and 5. The process 400 is appropriate when the volatile memory is being used as a cache and begins with a system power up (block 402). The host memory controller 116 determines if a restore operation is needed (block 404). As used herein, a restore operation is copying data from the persistent memory to the volatile memory using the backup memory controller. If the answer to block 404 is yes, then the host memory controller 116 commands a restore from persistent memory 316, 366 (block 406). This restore function will use information about what memory portions were stored. Thus, if the memory is a cache memory, the cache line and status tags will be restored with the data to the original addresses in DRAM by the backup memory controller 302, 352. Optionally, the restore may reference the touched bit map circuit 308, 358 and only restore those portions that were touched/stored (although as noted, such touched bit map circuit 308, 358 may not store all the information). For those portions of memory not backed up or modified, the host controller 116 may, on access to the unmodified and thus unrestored memory, cause a cache miss, which in turn will cause the host memory controller to bring the data back from the system main storage (e.g., a hard drive or solid-state drive). Alternatively, the entirety of the persistent memory 316, 366 is copied back to the volatile RAM 312, 362. After restore (or if no restore was needed at block 404), the process 400 continues with load and store commands being issued to the volatile RAM 312, 362 (block 408). The detection circuit 304, 354 (or 368) detects these load and store commands and updates the cache line status in memory (block 410) controlled by the backup memory controller 302, 352 (and optionally in the touched bit map circuit 308, 358) each time such a command issues. If such a command has not issued, the backup memory controller 302 or 352 monitors for a backup command or power failure (block 412) (i.e., a backup event). If there is no such occurrence, the process 400 repeats as noted. If, however, there is such an occurrence, then the backup memory controller 302 or 352 finds the portions of the volatile RAM 312, 362 having a modified status and then the address, cache line status, along with the data will be saved to persistent memory 316, 366 (block 414) and the process 400 concludes with a system power off (block 416).

The process 500 of FIG. 5 is appropriate when the volatile memory is being used as direct memory and begins with a system power-up (block 502). The host memory controller 116 determines if a restore operation is needed (block 504). If the answer to block 504 is yes, then the host memory controller 116 commands a restore from persistent memory 316, 366 (block 506). This restore function will use information about what memory portions were stored. Thus, if the memory is direct memory, the data and the metabits will be restored with the data to the original addresses in DRAM by the backup memory controller 302, 352. Optionally, the restore may reference the touched bit map circuit 308, 358 and only restore those portions that were touched/stored (although as noted, such touched bit map circuit 308, 358 may not store all the information). For those portions of memory not backed up or modified, the host controller 116 may restore the unmodified data from system main storage (e.g., hard drive or solid-state drive) either right after the backup memory controller 302, 352 completes the restore function or during host accesses of memory. The host memory controller 116 may have additional information on how to retrieve information that had not been modified and stored. Alternatively, the entirety of the persistent memory 316, 366 is copied back to the volatile RAM 312, 362. After restore (or if no restore was needed at block 504), the process 500 continues with load and store commands being issued to the volatile RAM 312, 362 (block 508). The detection circuit 304, 354 (or 368) detects these load and store commands and updates the metabits and the memory (block 510) controlled by the backup memory controller 302, 352 (and optionally in the touched bit map circuit 308, 358 each time such a command issues. If such a command has not been issued, the backup memory controller 302 or 352 monitors for a backup command or power failure (block 512) (e.g., a backup event). If there is no such occurrence, the process 500 repeats as noted. If, however, there is such an occurrence, then the backup memory controller 302 or 352 finds the portions of the volatile RAM 312, 362 indicated as having a modified status as indicated by the metabit and causes then the address and metabit along with the data to be saved to persistent memory 316, 366 (block 514) and the process 500 concludes with a system power off (block 516).

As a contemplated variation, the size (or number) of the backup energy source 130, 144 may be limited such that there is insufficient power to backup an entirety of the volatile RAM 124, 136. In such case, the controller 126, 140 may monitor how many lines have been moved to “modified” and compare this value to the capabilities of the backup energy source 130, 144. When a threshold is reached (e.g., 80-90%), the backup memory controller 126, 140 may trigger a pre-emptive backup (i.e., before receiving a command from the host memory controller 116 or power interruption event) and copy all modified lines into the persistent memory 128, 142. Some indication of this function and its operation may be provided (e.g., in the touched bit map circuits 308, 358) so that these pre-emptively stored sections are restored and so that when a power interrupt occurs, this pre-emptively stored data is not copied again, preserving the backup energy source 130, 144 for copying only those modified since the last such forced backup.

The systems and methods for selective backup of volatile memory to persistent memory, according to aspects disclosed herein, may be provided in or integrated into any processor-based device. Examples, without limitation, include a server, a storage server, a desktop computer, a laptop computer, or the like, as well as more specialized processor-based devices such as a set-top box, an entertainment unit, a navigation device, a communications device, a fixed location data unit, a mobile location data unit, a global positioning system (GPS) device, a mobile phone, a cellular phone, a smartphone, a session initiation protocol (SIP) phone, a tablet, a phablet, a server, a computer, a portable computer, a mobile computing device, a wearable computing device (e.g., a smartwatch, a health or fitness tracker, eyewear, etc.), a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, or the like.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. A memory device comprising:
a volatile random-access memory (RAM) portion comprising a memory access line having a status identifier associated therewith indicative of whether a change has been made over the memory access line;
a persistent memory portion;
a backup memory controller configured to:
detect a backup event; and
copy data from the volatile RAM portion to the persistent memory portion based on the status identifier.

2. The memory device of claim 1, wherein the volatile RAM portion is configured to access as cache memory, and the status identifier comprises a modified status.

3. The memory device of claim 1, wherein the volatile RAM portion is configured to access as direct memory, and the status identifier comprises at least one metabit.

4. The memory device of claim 1, further comprising a memory bus interface configured to convey data access requests from a host processor to the volatile RAM portion.

5. The memory device of claim 4, wherein the memory bus interface comprises a peripheral component interconnect express (PCIe) or compute express link (CXL) memory bus interface.

6. The memory device of claim 1, wherein the persistent memory portion comprises NAND flash memory.

7. The memory device of claim 1, wherein the backup memory controller is further configured to read the status identifier prior to a restore function.

8. The memory device of claim 1, wherein the backup memory controller is further configured to write the status identifier responsive to a memory access command.

9. The memory device of claim 1, further comprising an energy source device configured to provide power to the volatile RAM portion while data in the volatile RAM portion is copied into the persistent memory portion.

10. The memory device of claim 9, wherein the energy source device comprises a supercapacitor.

11. A method of backing up memory, comprising:
storing a status identifier related to a memory line associated with a volatile memory portion, the status identifier indicative of whether a memory access command has occurred; and
responsive to a backup event, copying data from a subset of the volatile memory portion to a persistent memory portion based on the status identifier.

12. The method of claim 11, further comprising not copying data from the volatile memory portion when the status identifier indicates no memory access command has occurred.

13. The method of claim 11, further comprising using an energy source device within the memory during the copying.

14. The method of claim 13, further comprising storing energy in the energy source device wherein stored energy is less than needed to copy all of the volatile memory portion into the persistent memory portion.

15. The method of claim 11, further comprising accessing the volatile memory portion through a compute express link (CXL) protocol.

16. The method of claim 11, wherein the status identifier comprises a cache line status of modified.

17. The method of claim 11, wherein the status identifier comprises metabits.

18. A computing device comprising:
a host memory controller;
a memory bus coupled to the host memory controller; and
a memory device coupled to the memory bus, the memory device comprising
a volatile random-access memory (RAM) portion comprising a memory access line having a status identifier associated therewith indicative of whether a change has been made over the memory access line;
a persistent memory portion;
a backup memory controller configured to:
detect a backup event; and
copy data from the volatile RAM portion to the persistent memory portion based on the status identifier.
